(19) United States
(12) Patent Application Publication
(10) Pub. No.: US 2006/0144674 A1
(43) Pub. Date: Jul. 6, 2006

(54) Method and unit for the formation of groups of products in a machine for continuous packaging of products

(76) Inventors: Nicola Baldanza, Casalecchio Di Reno (IT); Moreno Cremonini, Castello Serravalle (IT); Giordano Gorrieri, Pianoro (IT)

Correspondence Address: McCARTER & English, LLP;Four Stamford Plaza, 107 Elm Street, Stamford, CT, 06902, US

(21) Appl. No.: 11/291,685

(22) Filed: Dec. 1, 2005

(30) Foreign Application Priority Data
Dec. 1, 2004 (EP) 04425906.7

(51) Int. Cl. B65G 47/26

(52) U.S. Cl. 198/418.7

(57) ABSTRACT

Described herein is a method and a unit for the formation of groups of products in a machine for continuous packaging of products, according to which at least two continuous rows of products are fed via two conveyor devices set in series with respect to one another along a first given path and in contact with at least one alignment element, which is set transverse to the first path and in front of the rows of products to align the rows themselves with respect to one another, and is displaced along a second, loop-like, path defined by two portions, along which the alignment element is set on the inside and on the outside, respectively, of the first path.

The present invention relates to a method for the formation of groups of products in a machine for continuous packaging of products.

### BACKGROUND OF THE INVENTION

Machines for packaging of products currently on the market normally comprise one first conveyor device and one second conveyor device, which are set in series with respect to one another, are connected to one another in a position corresponding to a transfer station, and are designed to feed at least two continuous rows of products set alongside one another along a given path and in a given direction.

The rows of products are fed by the conveyor devices in contact with an alignment element set transverse to the aforesaid path and at a distance from the transfer station which is such as to enable each time transfer on the second conveyor device of a number of products equal to the number of products of a group.

Once the rows of products are set in contact with the alignment element, the first conveyor device is deactivated, and the alignment element is displaced, normally via at least one actuator cylinder, transverse to, and on the outside of, the aforesaid path to enable the second conveyor device to separate a group of products from the rows themselves.

Known packaging machines of the type described above present some drawbacks mainly deriving from the fact that said machines have a relatively low productivity on account of the dead times introduced by the displacements of the alignment element under the thrust of the aforesaid actuator cylinder.

### SUMMARY OF THE INVENTION

The purpose of the present invention is to provide a method for the formation of groups of products in a machine for continuous packaging of products which will be free from the drawbacks set forth above.

According to the present invention, a method for the formation of groups of products in a machine for continuous packaging of products is provided as claimed in the attached Claims.

The present invention further relates to a unit for the formation of groups of products in a machine for continuous packaging of products.

According to the present invention, a unit for the formation of groups of products in a machine for continuous packaging of products is provided as claimed in the attached Claims.

### BRIEF DESCRIPTION OF THE DRAWINGS

The present invention will now be described with reference to the annexed plate of drawings, which illustrate a non-limiting example of embodiment thereof, and in which:

FIGS. 1 to 6 are schematic side views of a preferred embodiment of the unit of the present invention illustrated in six different operating positions; and

FIG. 7 is a schematic plan view of the unit of FIG. 1.

### DETAILED DESCRIPTION OF THE INVENTION

With reference to the attached figures, the reference number 1 designates, as a whole, a unit for the formation of groups 2 (FIGS. 4, 5, and 6) of products 3 in a machine for continuous packaging of products 3, further provided with a wrapping unit 4 comprising a forming device 5, inside which a tubular casing (not illustrated) of wrapping material is formed, which is designed to receive in succession the groups 2 from the unit 1, and which is fed at a substantially constant rate along the device 5.

In the ensuing treatment, the products 3 considered are packs of rolls of paper, each of which consists of at least one roll of paper wrapped in a corresponding sheet of wrapping, to which the present description will make explicit reference without this however implying any loss in generality.

The unit 1 comprises a line 6 of advance, which extends along a given path P and in a substantially horizontal direction 7 and is defined by two conveyor devices 8, 9, which are set in series with respect to one another and are connected to one another in a position corresponding to a transfer station 10.

Each device 8, 9 comprises a respective bottom conveyor 11, 12, in turn comprising at least one belt 13 looped around a plurality of pulleys 14, one of which is motor-driven via an actuation device (of a known type and not illustrated), mounted so as to rotate about respective axes 15 of rotation substantially parallel to one another and to a horizontal direction 16 (FIG. 7) transverse to the direction 7. Each belt 13 has a top conveying branch 17 substantially coplanar with the branch 17 of the other belt 13 so as to define a resting surface A for the products 3.

Each device 8, 9 further comprises a respective top roller 18, 19 of advance, which extends in the direction 16, is set on the opposite side of the corresponding conveyor 11, 12 with respect to the products 3, and is mounted so as to rotate, under the thrust of an actuation device (of a known type and not illustrated), about an axis 20 substantially parallel to the axes 15.

In connection with what has been set forth above, it should be pointed out that the conveyor 12 and the roller 19 of the conveyor device 9 are displaced in a continuous way with the same law of motion as that of the aforesaid tubular casing (not illustrated) and that the conveyor 11 and the roller 18 of the conveyor device 8 are displaced with respective laws of motion independent of one another, which are controlled selectively by an electronic control unit (not illustrated) according to modalities that will be illustrated more clearly in what follows.

The roller 18 is set upstream of the station 10 in the direction 7, and is mobile, under the thrust of at least one actuator cylinder 21, in a vertical direction 22 orthogonal to the directions 7 and 16 between a raised resting position of disengagement from the products 3 and a lowered operating position of engagement of the products 3 themselves. The roller 19 is set downstream of the station 10 in the direction 7, and is mobile, under the thrust of at least one actuator cylinder 23, in the direction 22 between a raised resting position of disengagement from the products 3 and a lowered operating position of engagement of the products 3 themselves.

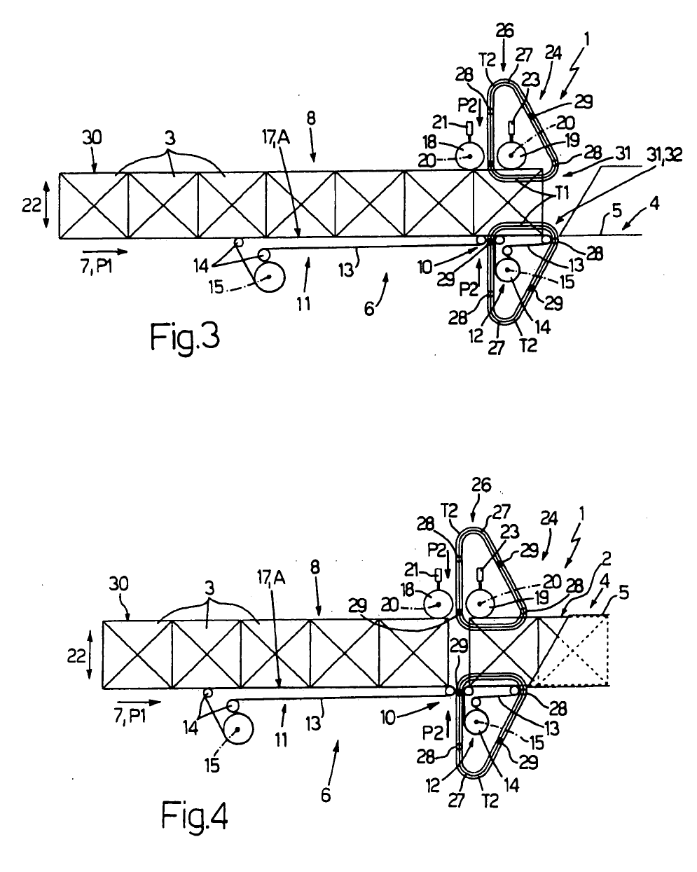

The unit 1 further comprises a device 24 for thrust and alignment, which, in turn, comprises a pair of bottom conveyors 25 (just one of which is illustrated in FIGS. 1 to 6) arranged on opposite sides of the conveyor 12 in the direction 16, and a pair of top conveyors 26 (just one of which is illustrated in FIGS. 1 to 6) arranged on opposite sides of the roller 19 in the direction 16.

Each conveyor 25, 26 comprises a chain 27 looped around a corresponding plurality of sprockets (not illustrated), one of which is motor-driven via an actuation device (of a known type and not illustrated) and which are mounted so as to rotate about respective axes of rotation (not illustrated) substantially parallel to one another and to the direction 16.

Each corresponding pair of chains 27 supports, in the case in point, two alignment rods 28, which extend between the corresponding chains 27 in the direction 16, and are uniformly distributed along the corresponding chains 27 themselves, and a pair of thrust rods 29, which extend between the corresponding chains 27 in the direction 16, are uniformly distributed along the corresponding chains 27 themselves, and are alternated to the corresponding rods 28. In particular, the distances of each thrust rod 29 from the corresponding alignment rods 28 are different from one another.

Each rod 28, 29 is fed by the corresponding conveyors 25, 26 in phase with a corresponding rod 28, 29 of the other conveyors 25, 26 and along a loop-like path P2 comprising two portions T1, T2, in a position corresponding to which the rod 28, 29 itself is set on the inside and on the outside, respectively, of the path P1.

Operation of the unit 1 will now be described with reference to FIGS. 1 to 6 and starting from an instant in which, according to what is illustrated in FIG. 1:

the two rollers 18 and 19 are arranged in their raised resting positions; and

the conveyors 11 and 12 co-operate with one another for feeding a plurality of continuous rows 30 of products 3 (in the case in point three rows 30) parallel to one another and to the direction 7 along the path P1, through the station 10, and in contact with a pair of alignment rods 28 fed by the corresponding conveyors 25, 26 along the portions T1 of the corresponding paths P2, i.e., inside the path P1.

The rows 30 are fed by the conveyor 11 in the direction 7 at a rate higher than the rate of the conveyor 12, and the rods 28 considered are fed in the direction 7 at a rate lower than the rate of the conveyor 12 so as to enable the rows 30, by combining the rate of the conveyors 11 and 12 and of the rods 28 considered, to be aligned to one another in the direction 16 up against the rods 28 themselves.

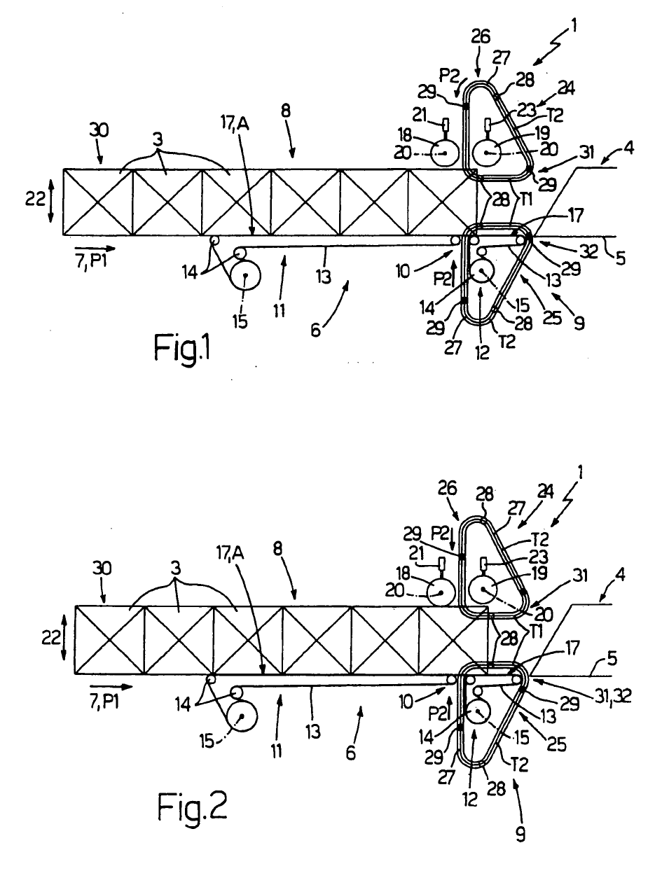

According to what is illustrated in FIGS. 2, 3, and 4, once the rows 30 have been aligned in the direction 16, the following operations are performed: the conveyor 11 and the rods 28 considered are fed in the direction 7 at the same speed as the conveyor 12 and, hence, as the aforesaid tubular casing (not illustrated); the rollers 18 and 19 are displaced in their lowered operating positions and co-operate with the conveyors 11 and 12 so as to feed a number of products 3 corresponding to a group 2 downstream of the station 10 in the direction 7 and so as to insert the products 3 arranged at the front in the direction 7 itself into the forming device 5; and the conveyors 25, 26 are in the first place accelerated so as to disengage the rods 28 considered from the rows 30 and from the portion T1 of the path P2 and are then stopped in such a way that all the rods 28, 29 are arranged along the portion T2 and, consequently, on the outside of the path P1.

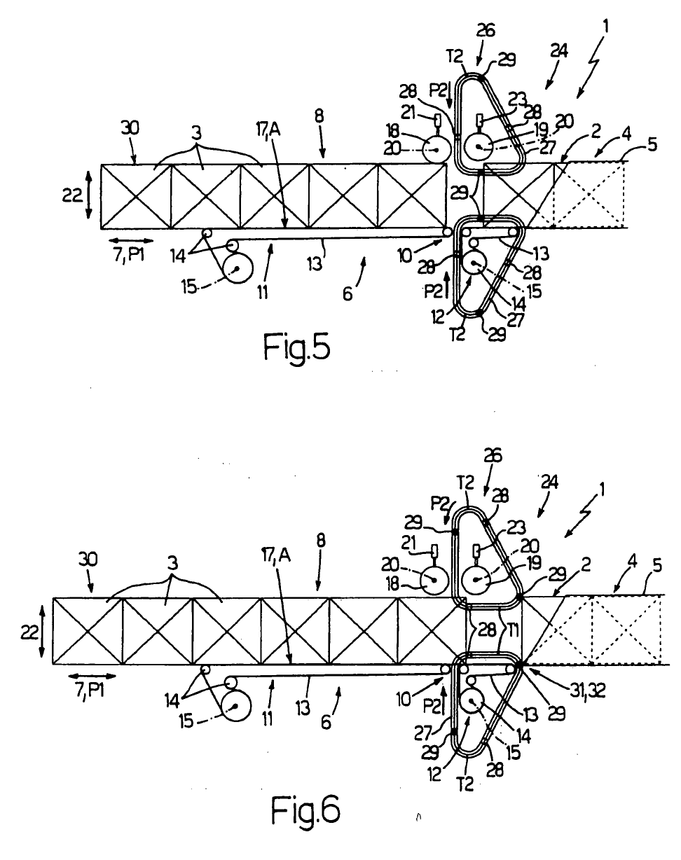

At this point, the conveyor 11 and the roller 18 are stopped to enable the conveyor 12 and the roller 19 to separate the group 2 just formed from the rows 30 (FIG. 4), and the conveyors 25, 26 are actuated again so as to accelerate a pair of thrust rods 29 along the stretch T1 and in contact with the group 2 itself (FIG. 5).

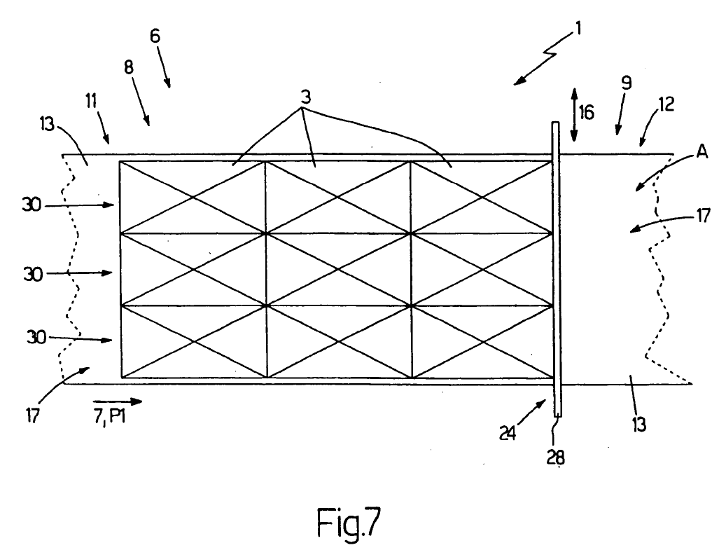

With reference to FIGS. 5 and 6, once the rods 29 have been set in contact with the group 2, they are fed at the same rate as that of the conveyor device 9 and, hence, of the aforesaid tubular casing (not illustrated) and co-operate with the conveyor device 9 itself for feeding the group 2 within the forming device 5, whilst the roller 19 is displaced into its raised resting position.

In this regard, it should be pointed out that the paths P2 are shaped in such a way that the corresponding portions T1 will have respective output ends 31 arranged substantially in a position corresponding to one input end 32 of the device 5 to enable the thrust rods 29 to disengage the group 2 only when all the corresponding products 3 have been completely fed through the end 32 itself.

Finally, according to what is illustrated in FIG. 6, the speed of the conveyors 25 and 26 is selectively controlled to feed a new pair of rods 28 on the inside of the path P1 and the rods 29 considered on the outside of the path P1 itself, the roller 18 is displaced into its raised resting position, the conveyor 11 is again actuated for displacing the rows 30 in contact with the new rods 28, and the operating sequence described above is repeated for the formation of a new group 2 of products 3.

1. A method for the formation of groups (2) of products (3) in a machine for continuous packaging of products (3), the method comprising the steps of:
feeding a plurality of products (3) ordered in least two continuous rows (30) set alongside one another via first and second conveyor means (8, 9), which are set in series with respect to one another, are connected together in a position corresponding to a transfer station (10), and are designed to feed said rows (30) along a first given path (P1) and in a first given direction (7);
feeding said rows (30) in contact with at least one alignment element (28) set transverse to the first path (P1) and in front of the rows (30) in said first direction (7) for aligning the rows (30) themselves in a second direction (16) transverse to said first direction (7);
disengaging the alignment element (28) from the first path (P1);
feeding a plurality of products (3) defining a corresponding group (2) of products (3) through said transfer station (10); and
stopping the first conveyor means (8) for separating the group (2) just formed from the rows (30);
said method being characterized in that it further comprises the step of:
displacing the alignment element (28) along a second, loop-like, path (P2), comprising a first portion (T1), in a position corresponding to which the alignment element (28) is set on the inside of the first path (P1), and a second portion (T2), in a position corresponding to which the alignment element (28) is set on the outside of the first path (P1) itself.

2. The method according to claim 1 and further comprising the step of feeding each group (2) of products (3) within a tubular casing made of wrapping material via at least one thrust element (29) set transverse to the first path (P1) and behind the group (2) itself in said first direction (7).

3. The method according to claim 2 and further comprising the step of displacing the thrust element (29) along a third, loop-like, path (P2), comprising a first stretch (T1), in a position corresponding to which the thrust element (29) is set on the inside of the first path (P1), and a second stretch (T2), in a position corresponding to which the thrust element (29) is set on the outside of the first path (P1) itself.

4. The method according to claim 2 and further comprising the step of disengaging the thrust element (29) from each group (2) of products (3) when the entire group (2) is set within at least part of said tubular casing.

5. The method according to claim 2 and further comprising the step of disengaging the thrust element (29) from each group (2) of products (3) when the alignment element (28) is engaged by said rows (30).

6. The method according to claim 2 and further comprising the step of imparting on said first and second conveyor means (8, 9) respective laws of motion independent of one another; the law of motion of said second conveyor means (9) being substantially equal to a law of motion of displacement of said tubular casing.

7. The method according to claim 2 and further comprising the step of feeding the thrust element (29), when this is set in engagement of a group (2) of products (3), at a speed substantially equal to the speed of the tubular casing.

8. The method according to claim 1 and further comprising the step of displacing the alignment element (28) along part of said first portion (T1) at a speed slower than the speed of the first conveyor means (8) to enable the rows (30) to engage the alignment element (28) itself.

9. The method according to claim 1, in which said first and second conveyor means (8, 9) comprise a first conveyor device (11) and a second conveyor device (12), respectively, set in series with respect to one another to define a resting surface (A) for the products (3), and a third conveyor device (18) and a fourth conveyor device (19), respectively, which are designed to engage the products (3) on the side opposite to said first and second conveyor devices (11, 12); the method comprising the step of displacing and maintaining the third and fourth conveyor devices (18, 19) in a resting position of disengagement of the products (3) when the rows (30) come into contact with said alignment element (28).

10. The method according to claim 9 and comprising the step of displacing and maintaining the fourth conveyor device (19) in an operating position of engagement of each group (2) of products (3) during at least part of the step of insertion of the group (2) itself into said tubular casing.

11. The method according to claim 10 and comprising the step of displacing the fourth conveyor device (19) from its operating position into its resting position when the thrust element (29) comes into contact with a group (2) of products (3).

12. A unit for the formation of groups (2) of products (3) in a machine for continuous packaging of products (3), the unit comprising: first and second conveyor means (8, 9), which are set in series with respect to one another, are connected together in a position corresponding to a transfer station (10), and are designed to feed a plurality of products (3) ordered in least two continuous rows (30) set alongside one another along a first given path (P1) and in a first given direction (7); and at least one alignment element (28), which is set transverse to the first path (P1) and is designed to engage the rows (30) at the front in the first direction (7) for aligning the rows (30) themselves in a second direction (16) transverse to the first direction (7); said unit being characterized in that it further comprises first actuator means (25, 26) for displacing the alignment element (28) along a second, loop-like, path (P2) comprising a first portion (T1), in a position corresponding to which the alignment element (28) is set on the inside of the first path (P1), and a second portion (T2), in a position corresponding to which the alignment element (28) is set on the outside of the first path (P1) itself.

13. The unit according to claim 12 and further comprising logic control means for selectively controlling the speed of said first and second conveyor means (8, 9) so as to separate in succession the groups (2) of products (3) from the rows (30).

14. The unit according to claim 12 and further comprising at least one thrust element (29), which is set transverse to the first path (P1) and is designed to engage each group (2) of products (3) at the rear in the first direction (7) for feeding the group (2) itself within a tubular casing made of wrapping material.

15. The unit according to claim 14 and further comprising second actuator means (25, 26) for displacing the thrust element (29) along a third, loop-like, path (P2) comprising a first stretch (T1), in a position corresponding to which the thrust element (29) is set on the inside of said first path (P1), and a second stretch (T2), in a position corresponding to which the thrust element (29) is set on the outside of the first path (P1) itself.

16. The unit according to claim 15, in which said first stretch (T1) has an output end (31) set along the first path (P1) substantially in a position corresponding to an input end (32) of said tubular casing.

17. The unit according to claim 15, in which the first portion (T1) of the second path (P2) and the first stretch (T1) of the third path (P2) extend along said second conveyor means (9).

18. The unit according to claim 15, in which said second and third paths (P2) coincide substantially with one another.

19. The unit according to claim 12, in which said first and second conveyor means (8, 9) comprise a first conveyor device (11) and a second conveyor device (12), respectively, set in series with respect to one another to define a resting surface (A) for the products (3), and a third conveyor device (18) and a fourth conveyor device (19), respectively, which are designed to engage the products (3) on the side opposite to said first and second conveyor devices (8, 9).

20. The unit according to claim 19 and further comprising third actuator means (21) for displacing the third conveyor device (18) between a first resting position of disengagement of the products (3) and a first operating position of engagement of the products (3) themselves, and fourth actuator means (23) for displacing the fourth conveyor device (19) between a second resting position of disengagement of the products (3) and a second operating position of engagement of the products (3) themselves.
